(19) United States
(12) Patent Application Publication
(10) Pub. No.: US 2008/0206879 A1
(43) Pub. Date: Aug. 28, 2008

(54) Analysis of Functional Fluids Using a Redox Indicator

(75) Inventors: Gilbert R. Malone, Perry, OH (US); Harshida C. Dave, Highland Heights, OH (US)

Correspondence Address: THE LUBRIZOL CORPORATION;ATTN: DOCKET CLERK, PATENT DEPT., 29400 LAKELAND BLVD., WICKLIFFE, OH, 44092, US

(73) Assignee: The Lubrizol Corporation, Wickliffe, OH (US)

(21) Appl. No.: 11/679,916

(22) Filed: Feb. 28, 2007

(51) Int. Cl. G01N 21/77

(52) U.S. Cl. 436/60; 436/169

(57) ABSTRACT

The present invention relates to the analysis of the quality of functional fluids. In particular, the invention relates to using a stable redox indicator that produces a color at the presence of oxidation byproducts in a functional fluid.

### FIELD OF THE INVENTION

The present invention relates to the analysis of the quality of functional fluids. In particular, the invention relates to using a stable redox indicator that produces a color in the presence of oxidation byproducts in a functional fluid.

### BACKGROUND OF THE INVENTION

Functional fluids are employed in a variety of automotive, off-highway vehicles, on-highway vehicles, equipment, machines, metal working and industrial applications. It is important to know the quality and condition of such functional fluids to prevent the improper and ineffective utilization of the functional fluid. A quality functional fluid insures that the condition of the device/equipment containing the functional fluid is productive and properly functioning. It is, therefore, desirable to monitor the physical and/or chemical conditions of functional fluids.

Methods exist for the analysis of functional fluids for using various reagents in determining the presence and/or concentration of various constituents of the functional fluids. Specific reagents may be employed for determining the presence and concentration of components in functional fluids. These methods generally analyze for pH, coloring agents, and contaminants using reactive reagents on test strips. These methods generally require controlled conditions. Further, these methods may be subjective and inaccurate.

It would be desirable to have an accurate and easy analytical method to determine conditions of a functional fluid. It would further be desirable to have an accurate analytical method to determine fluid condition and to use it in the field.

Redox indicators have been used in analytical methods for monitoring fluids. Generally, redox indicators are sensitive in the presence of air. The instability of redox indicators have made them not useful for analytical tests that monitor fluid conditions. It would be desirable to have a stable redox indicator that is easy to use to determine the condition of a functional fluid. A need exists for a simple and rapid method of chemically analyzing a functional fluid to determine its condition, quality, or other useful properties.

It is an object of this invention to provide an easy, convenient, and accurate method of analysis of the condition and quality of a functional fluid. It is a further object of the invention to provide a stable redox indicator on a test medium that can identify oxidation byproducts in a functional fluid which thus identifies the quality and condition of the functional fluid. It is an object of this invention to indicate a time when the functional fluid should be additized and/or changed.

### SUMMARY OF THE INVENTION

The present invention is a method to determine the condition of a functional fluid comprising
(1) obtaining a sample of the functional fluid,
(2) contacting the sample of the functional fluid on a test medium impregnated with a stable reduced indicator (dye) that produces a change in color in response to oxidizing species in the functional fluid,
(3) waiting for an effective period of time for the functional fluid sample to react with the indicator to produce the change in color, and
(4) analyzing the results of the reaction by determining or comparing the resultant color change resulting from the oxidized form of the dye; and
(5) determining the condition of the functional fluid.

The invention further provides a test kit for the analysis of functional fluids comprising a test medium treated with a stable reduced indicator and visual indicia or printed instructions depicting the condition of a functional fluid disposed upon the test medium when reacted with the reduced indicator.

### DETAILED DESCRIPTION OF THE INVENTION

The present invention provides a method and device such as a kit for analyzing and monitoring the condition of functional fluids. The functional fluids comes from innumerable sources, including internal combustion engines, stationary engines, turbines, transmissions, differentials, pumps, metalworking operations, cooling systems, and the like. The functional fluids include automatic transmission fluids, traction drive transmission fluids, manual transmission fluids, power steering fluids, antifreeze fluids, lubricating oils, greases, crankcase lubricants, mineral oils, oils with Group 1 base oils, differential lubricants, turbine lubricants, gear lubricants, gear box lubricants, axle lubricants, farm tractor fluids, transformer fluids, compressor fluids, cooling system fluids, metal working fluids, hydraulic fluids, industrial fluids, fuels, continuously variable transmission fluids, infinitely variable transmission fluids, and the like. In one embodiment, the functional fluid is an automatic transmission fluid. In one embodiment, the functional fluid is compressor fluids such as air compressor lubricants and turbine lubricants.

Oxidation byproducts occur due to the oxidation of the functional fluid over its life. The analysis detects the functional fluids oxidized and/or oxidizing species or oxidation byproducts that result from use of the fluid itself. Generally, functional fluids contain oxidation inhibitors in additive packages to prevent and/or delay the oxidation of the functional fluid. The oxidation byproduct and/or oxidizing species generally build up in the functional fluid after the depletion of oxidation inhibitors. The oxidizing species and/or oxidation byproducts in the functional fluid demonstrate that the condition of the functional fluid has exceeded its useful life and should be changed for proper utilization of the functional fluid.

The oxidation byproducts/oxidizing species that the redox indicator determines include hydroperoxides, peroxides, oxides of nitrogen, nitrogen oxides, and the like. In one embodiment, the oxidizing byproduct is peroxide. The method can determine one or more combinations of the oxidation byproducts and/or oxidizing species.

The concentration of oxidation byproducts/oxidizing species in the functional fluid is at least concentration greater than about 1 ppm, in another embodiment greater than about 0.5 ppm, and in another embodiment greater than about 0.1 ppm of calculated as equivalents of hydroperoxide.

Indicator Reagents

Indicator reagents for the purposes of this invention are substances that enable the state of a chemical system to be characterized. The indicator is a redox indicator or combination of redox indicators.

The choice of redox indicators depends on the type of functional fluid being tested and/or the oxidative potential of the byproducts formed.

The redox indicators function by a color change as seen through visual examination, colorimetry, photometry, fluorescence, chemiluminescence and the like.

The color of the redox indicator is chosen depending on the type of functional fluid being tested and/or the level of degradation of the functional fluid. Certain colors contrast strongly to the usual color of the functional fluid which is preferred. The choice of a suitable color may be determined by a particular application. For example, in one embodiment automatic transmission fluid for passenger cars is colored red for identification purposes. It would be inappropriate to use an indicator that turns red to indicate an unacceptable condition in the functional fluid of an automatic transmission fluid. For example, in an automatic transmission fluid, a selection of the color indication is in the range of varying blues to greens and mixtures thereof would be desired.

Redox indicators include neutral red, safranine T or O, indigo, indigo carmine, methylene blue, thionine, thymolindophenol, 2,6-dichlorophenolindophenol, gallocyanine, nile blue, variamine blue, diphenyl amine, diphenylamine-4-sulfonic acid, barium salt, tris(2,2-dipyridyl)iron(II)sulfate, N-phenylanthranilic acid, ferroin, nitroferroin, 5,6-dimethylferroin, 4-amino-4′-methyldiphenylamine, diphenylbenzindine-disulfonic acid, o-dianisidine, 3,3′-dimethylnaphthidine, 3,3′-dimethylnaphthidine disulfonic acid, bis(5-bromo-1,10-phenanthroline)ruthenium(II)dinitrate, tris(5-nitro-1,10-phenanthroline)iron(II)sulfate, Iron(II)-2,2′,2″-tripyridine sulfate, tris(4,7-biphenyl-1,10-phenanthroline)iron(II)disulfate, o,m′-diphenylaminedicarboxylic acid setopaline, p-nitrodiphenylamine, tris(1,10-phenanthroline)-iron(II) sulfate, setoglaucine O, xylene cyanole FF, erioglaucine A, eriogreen, tris(2,2′-bipyridine)-iron(II)hydrochloride, 2-carboxydiphenylamine[N-phenyl-anthranillic acid], benzidine dihydrochloride, o-toluidine, bis(1,10-phenanthroline)-osmium(II)perchlorate, diphenylamine-4-sulfonate Na salt), 3,3′-dimethoxybenzidine dihydrochloride[o-dianisidine], ferrocyphen, 4′-ethoxy-2,4-diaminoazobenzene, N,N-diphenylbenzidine, diphenylamine, N,N-dimethyl-p-phenylenediamine, variamine blue B hydrochloride, N-phenyl-1,2,4-benzenetriamine, bindschedler's green, 2,6-dichloroindophenol (Na salt), 2,6-dibromophenolindophenol, brilliant cresyl blue [3-amino-9-dimethyl-amino-10-methylphenoxyazine chloride], Iron(II)-tetrapyridine chloride, starch (soluble potato, I₃ present), gallocyanine (25° C.), nile blue A [aminonaphthodiethylamino-phenoxazine sulfate], Indigo-5,5′,7,7′-tetrasulfonic acid (Na salt), Indigo-5,5′,7-trisulfonic acid (Na salt), Indigo-5,5′-disulfonic acid (Na salt), phenosatranine, indigo-5-monosulfonic acid (Na salt), bis(dimethylglyoximato)-iron(II)chloride, Induline scarlet, and the like. In one embodiment, the redox indicators are methylene blue, p-nitrodiphenyl-amine, N,N-diphenylbenzidine, diphenylamine, neutral red and the like. In one embodiment, the redox indicator is methylene blue.

The redox indicators can be used alone or in combinations. The redox indicators are used in the range of about 0.01 wt. % to about 1 wt. %, and in another embodiment are used in the range of about 0.05 wt. % to about 1 wt. % and in another embodiment are used in the range of about 0.1 wt. % to about 1 wt % in the solution applied to the test medium. The solvent is then evaporated from the solution.

The redox indicators may already be in a reduced form or is reduced in solutions using reducing agents such as phosphoric acid, dithiophosphoric acid, sodium borohydride, aluminium hydride and the like. The reducing agents may be used alone or in combination. The reducing agent is used in the range of about equal to or greater than 1 equivalent based on the amount of redox indicators being reduced.

Optionally, in preparing the stable redox indicators, stabilizers are added. The stabilizers include inhibitors such as para-amino benzoic acid, phenyl alpha-napthal amines and the like. Another class of stabilizers include acids such as hydrochloric acid, dithio-phosphoric acid, phosphoric acid, thio-phosphoric acids. The stabilizers can be used alone or in combination. The stabilizer is employed in the range 1 equivalent to or greater than the amount of redox indicator being reduced.

In one embodiment, about 0.5 wt. % methylene blue is prepared in a solution of isopropyl alcohol. To that solution is added excess of about 2.5 equivalents of di(2-ethylhexyl)dithiophosphoric acid resulting in the methylene blue reduced to its colorless form (II). The excess of the dithiophosphoric acid forms a salt of the reduced methylene blue and stabilizes it. This solution is applied to a test medium. The solvent is evaporated to provide a redox indicator test medium used to effectively evaluate functional fluids for oxidizing species and/or oxidizing byproducts such as peroxide.

Often a combination of an acid and a reducing agent may be used along with the redox indicator. One agent may be both as with a dithiophosphoric acid, or two separate materials may be used. For example, along with the redox indicator such as methylene blue, one might use hydrochloric acid (HCL) and sodium thiosulfate. Other examples and acid and the reducing agent combination might be sodium bisulfate and a zinc dialkyldithiophosphate (ZDDP), or phosphoric acid (H3PO4) and ZDDP. Another example of a single reagent providing both the acid and reducing agent would be sodium bisulfate (NaHSO3). Any of these may optionally include a catalytic metal ion of metals such as Cu, Fe, Mo or Mn. In some instances the amount of reducing agent is in excess of the redox indicator material, by a stoichiometric factor of 1.1, 1.5, 2 or 10 for example. The excess or reserve reduction potential adds additional stability to the indicator system.

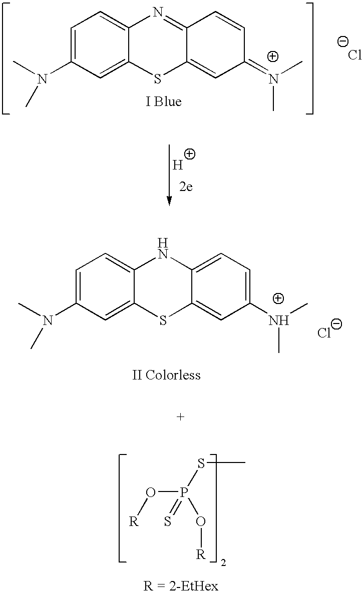

Test Medium

The functional fluid to be tested is placed upon an appropriate test medium. This test medium may be comprised of absorbent material, nonabsorbent material and combination thereof. The test medium includes paper, cellulosic material such as cellulose, cellulose nitrate, cellulose acetate, cellulosic material, wood, paper, chromatography paper, filter paper, polymeric fibers, natural fibers, finely woven fabrics, metal, glass, glass micro fiber, sintered glass, silica and/or alumina coated surfaces such as thin layer chromatography plates, plastic, plastic laminated material, composites, cotton, cloth, and combinations thereof. Other absorptive/adsorptive materials, having the, general physical properties and characteristics of chromatography paper are also be acceptable. The test medium must be capable of receiving a sample of the functional fluid. The test medium must be compatible with the redox indicator.

Light colored test medium provides a consistent background which contrasts well with most functional fluids, and provides for a more conspicuous color change and has the proper adsorptive affinity for the various components of the functional fluid. For example, the coloration of the redox indicator becomes more pronounced over time on the outer edges of the sample spot on the paper as the indicator colored portion of the mixture is swept along with the mobile phase (functional fluid and solvent) faster than the darker components of the used functional fluid, such as sludge. This is due to the differences in adsorptive affinity for the paper. In one embodiment, the test medium is white. In one embodiment the test medium includes “Whatman” white colored chromatography paper or filter paper in the form of an easy to dispense and use wipe.

The test medium may differ in its adsorptive affinity for the various components in the particular functional fluid, such as porosity, density, wicking ability, or other physical characteristics such as color.

The shape of the test medium is unimportant, so long as it is of an effective size to permit dispersion of the functional fluid sample, but small enough to be economical and limit waste. The test medium may be provided in a sealed envelope or package made of plastic or some other suitable material. The package may be designed to be held in the hand and opened on one side exposing the treated test medium for convenient usage yet protecting the users hand from contacting the test functional fluid or the indicator system adding to the convenience of the unit. Additionally, the test medium could be provided in a multi-unit dispenser tub for high volume applications in for example an automotive service station.

Solvents

The test medium can be dry or wet. In one embodiment where the test medium is wet it is due to the use of a solvent on the test medium. Suitable solvents include aliphatic, unsaturated and aromatic hydrocarbons, alcohols, glycols, glycol ethers, lower alcohols, such as methanol, ethanol and propanol, ethers, esters, amides, water and the like. Combination of solvents may be used.

The solvent is used in the range of about 1% to about 99.9%, in one embodiment about 5% to about 98% and in another embodiment about 1% to about 95.5% of the redox indicator solution. The solvent used depends on the type of functional fluid being tested. Combinations of solvents are also useful when the redox indicator, depending on the application and type of analysis desired, is not soluble in the functional fluid. Particularly, solvents or combinations of solvents which present a desirable combination of properties including good solvency power and miscibility with the functional fluid and the redox indicator, low vapor pressure at ambient temperatures, high flash points and the like.

Optional Components

Optional components may be added to the indicator solutions. These include surfactants to help media wetting, maskants and fragrances to improve customer appeal, antifoam additives to improve product manufacture and use, acids and bases to adjust the ph of the indicator solutions and buffers to maintain the pH of the indicator solutions. The optional components can be used alone or in combination.

Examples of surfactants include ionic, anionic (based on sulfate, sulfonate or carboxylate anions), sodium dodecyl sulfate (sds), ammonium lauryl sulfate, and other alkyl sulfate salts, sodium laureth sulfate, also known as sodium lauryl ether sulfate (sles), alkyl benzene sulfonate, soaps, or fatty acid salts, cationic (based on quaternary ammonium cations), cetyl trimethylammonium bromide (ctab) a.k.a. hexadecyl trimethyl ammonium bromide, and other alkyltrimethylammonium salts, cetylpyridinium chloride (cpc), polyethoxylated tallow amine (poea), benzalkonium chloride (bac), benzethonium chloride (bzt), zwitterionic (amphoteric), dodecyl betaine, dodecyl dimethylamine oxide, cocamidopropyl betaine, coco ampho glycinate, nonionic, alkyl poly(ethylene oxide), alkyl polyglucosides, including: octyl glucoside, decyl maltoside, fatty alcohols, cetyl alcohol, oleyl alcohol, cocamide mea, cocamide dea, cocamide tea, neodol 25, fatty alcohols, ethoxylated alcohols, alkyl polyglucosides, triton bg-10 surfactant, triton cg-110 surfactant, branched secondary alcohol ethoxylates, tergitol tmn series, ethylene oxide/propylene oxide copolymers, tergitol I series, tergitol xd, xh, and xj surfactants, triton cf surfactants, triton df surfactants, tergitol minfoam surfactants, nonylphenol ethoxylates, tergitol np series, octylphenol ethoxylates, triton x series, secondary alcohol ethoxylates, tergitol 15-s series, triton ca surfactant, triton n-57 surfactant, triton x-207 surfactant, surfynol surfactants, primary amines, tertiary amines, monoalkyl and polyamines, ethoxylated amines, ethoxylated diamines, propoxylated amines, amine salts, quaternary ammonium salts, ethoxylated quaternary salts, propoxylated quaternary salts, amine oxides, amides, ethoxylated amides, esters: nonionic surfactants: ethoxylated fatty acids, amphoteric compounds, sulfosuccinates and sulfosuccinimates, fatty acid esters, fatty alcohols, alkanolamides, alkyl and alkyl ether sulfates, lauryl sulfates and lauryl ether sulfates, alkyl aryl sulfonates and alpha olefin sulfonates, alkoxylated nonionic surfactants, soya lecithins, alkyl sulfates, alkyl ether sulfates, imidazolines, alkanolamides, dowfax anionic surfactants, dupont sulfonates, zonyl fluorosurfactants, peg esters and glyceryl esters, sorbitan esters/sorbitan ester ethoxylates, silicone surfactants, naphthalene condensates, sodium alkylnaphthalene sulfonates, pegol block copolymers, alkyl pyrrolidones, alkyl and glycol esters, emerest and trydet ethoxylated fatty acids and polyethylene glycol fatty acid esters, pilot hydrotropes, aristonate petroleum sulfonates, aristol sulfonatable oils, amido-amines, betaine amphoterics imidazolines imidazolinium amphoterics sulfosuccinates, fatty acid diethanolamides, neodol alcohols and the like. The surfactants can be used alone or in combination.

Examples of maskants and fragrances include abbarome 011, acalea tt, allyl amyl glycolate, ambrettolide, amyl cinnamic aldehyde, amyl salicylate, andrane, anethole 21/22, anethole usp, anethole usp, aphermate, apo patchone, bacdanol, benzyl butyrate, benzyl propionate, benzyl salicylate, bicyclononalactone, bornafix, canthoxal, cashmeran, cassiffix, cedramber, cedrenyl acetate, celestolide, cinnamalva, citral dimethyl acetal, intarome cotton odorsynthesis, intarome lavender musk odorsynthesis, citronalva, citronellol 700 jax, citronellol 750, citronellol 950, citronellol coeur, citronellyl acetate a, citronellyl acetate coeur, citronellyl acetate pure, citronellyl formate, clarycet, clonal, coniferan, cyclabute, cyclacet, cyclaprop, cyclemone a, cyclobutanate, cyclogalbaniff, cyclohexyl ethyl acetate, cyclohexyl ethyl alcohol, damascol 4, decyl methyl ether, delta damascone, dihydro cyclacet, dihydro floralate, dihydro floralol, dihydro myrcenyl acetate, dihydro terpineol, dihydro terpinyl acetate, dihydro terpinyl acetate dsa, dimethyl benzyl carbinol, dimethyl benzyl carbinyl acetate, dimethyl benzyl carbinyl butyrate, dimethyl cyclormol, dimethyl octanol, dimethyl phenyl ethyl carbinyl acetate, dimyrcetol, diola, dipentene 5100, dulcinyl recrystallized, ethyl ortho methoxy benzoate, ethyl phenyl glycidate, fleuramone, fleuranil, floralate, floralol, floralozone, fraistone, fructone, galaxolide 50 bb, galaxolide 50 dep, galaxolide 50 dpg, galaxolide 50 ipm, galbanum coeur, gelsone, geraldehyde, geraniol 5020, geraniol 7030, geraniol 980 pure, geraniol coeur, geranyl acetate a, geranyl acetate extra, geranyl acetate pure, grisalva, helional, herbac, hexalon, hexenyl salicylate, cis-3, hexyl acetate, hexyl cinnamic aldehyde, hexyl salicylate, hyacinth body, hyacinth body no.3, hydratropic aldehyde dimethyl acetal, hydroxyol, hypo-lem, indolarome, indolene 50, intreleven aldehyde, intreleven aldehyde special, ionone 100%, ionone alpha, ionone alpha beta regular, ionone beta, iso amyl butyrate, iso amyl salicylate, iso bornyl propionate, iso butyl quinoline, iso cyclemone e, iso cyclo citral, iso cyclo geraniol, iso e super, isoproxen, jasmal, jasmelia, jessemal, kharismal, koavone, kohinool, lavonax, lemsyn, liffarome, lindenol, lyral, lyrame, lyrame super, maritima, meijiff, melafleur, methyl cedryl ketone chinese, methyl cinnamic aldehyde alpha, methyl ionone gamma a, methyl ionone gamma coeur, methyl ionone gamma pure, methyl lavender ketone, montaverdi, muguesia, muguet aldehyde, muguet aldehyde 50 bb5O, myrac aldehyde, myrcenol super, myrcenyl acetate, neoproxen, nerol 800, nerol 850, nerol 900, neryl acetate jax, ocimene, ocimenyl acetate, octacetal, orange flower ether, orivone, orriniff 25% ipm, oxaspirane, ozofleur, pamplefleur, peomosa, phenafleur, phenoxanol, phenoxyethyl iso butyrate, phenoxyethyl propionate, phenyl ethyl acetate, phenyl ethyl alcohol, phenyl ethyl benzoate, phenyl ethyl formate, phenyl ethyl iso butyrate, phenyl ethyl salicylate, piconia, precyclemone b, prenyl acetate, proflora, pseudo linalyl acetate, reseda body, rosalva, rosamusk, roseate, rosemarel, salicynalva, sanjinol, santaliff, spirodecane, strawberiff, styralyl propionate, syvertal, terpineol 900, terpineol alpha jax, terpineol extra, terpinolene 20, terpinolene 90, terpinolene 90 pq, terpinyl acetate extra, terpinyl acetate jax, tetrahydro muguol, tetrahydro muguol coeur, tetrahydro myrcenol, tetrameran, tobacarol, triplal, unipine 60, unipine 85, vandor b, vanoris, verdol, verdox, verdox hc, verdural b extra, verdural extra, vertenex, vertenex hc, vertofix coeur, vertoliff, vigoflor, violiff, and mixtures thereof. also included in maskants are additives that act as odor scavengers such as amine scavengers and hydrogen sulfide scavengers like epoxides, basic amines, and the like. The maskants and fragrances can be used alone or in combination.

Examples of antifoams/defoamers are polysiloxanes, esters, insoluble oils, mineral oils, surfactants, amorphous silica, silicone emulsions, and the like. The antifoams/defoamers can be used alone or in combination.

Examples of acids include perchloric acid, hydroiodic acid, hydrobromic acid, hydrochloric acid, sulfuric acid, nitric acid, hydronium ion, chloric acid, bromic acid, perbromic acid, iodic acid, and periodic acid, fluoroantimonic acid, magic acid fso₃hsbf₅, carborane superacid h(chb₁₁cl₁₁), fluorosulfuric acid fso₃h, triflic acid cf₃so₃h , phosphoric acid, carboxylic acids, phenol, aromatic acids and the like. This can also include acidic buffer solutions. The acids can be used alone or in combination.

Examples of bases include potassium hydroxide, barium hydroxide, cesium hydroxide, sodium hydroxide, strontium hydroxide, calcium hydroxide, lithium hydroxide, rubidium hydroxide, butyl lithium, lithium diisopropylamide, sodium amide, sodium hydride, sodium carbonate, potassium carbonate, magnesium carbonate, ammonium carbonate, alanine, ammonia, nh₃ magnesium hydroxide, mg(oh)₂, amine bases such as: methylamine, pyridine and the like. The bases can be used alone or in combination.

Examples of aqueous buffers include combinations of ammonium chloride and ammonia, formic acid and sodium formate, acetic acid and sodium acetate, and the like. The buffers can be used alone or in combination.

The optional component is used in the range of about 0% to about 20% wt, in one embodiment about 0.01% to about 5% wt, and in another embodiment about 0.1% to about 2% wt of the reagent solution.

Visual Indicia

Analysis in particular qualitative analysis of the reacted test sample is accomplished by visual inspection of the reacted test sample using a provided visual indicia as a guide. Analysis occurs after an effective period of time to allow for the reaction between the components of the functional fluid and the redox indicator. Generally the time for reaction is in the range of about 1 sec. to about 1 hour, in another embodiment about 30 sec. minute to about 30 minutes, in another embodiment about 1 minute to about 15 minutes, and in another embodiment about 1 minute to about 5 minutes.

The visual indicia include an artistic rendering, a reproduction of a photograph of a functional fluid in various conditions with and without oxidizing species and/or oxidization byproducts, color key, a written description of the color change and the like. Combinations of visual indicia may be used. The visual indicia generally include one representation, two representations and more than two representations of the functional fluid disposed upon the test media in various conditions with and without oxidizing species and/or oxidization byproducts. In one embodiment the preferred visual indicia is one in an unacceptable condition containing oxidizing species and/or oxidization byproducts and one in acceptable condition. A descriptive text corresponding to each of these examples may be provided with the kit or packaged product.

In one embodiment the visual indicia depicted is dispersed upon the same or similar medium provided in the kit, to assure that the kit user compares the sample to be tested to examples produced under similar conditions. It is to be understood that a different number of indicia may be provided.

Method

The method comprises the steps of (a) obtaining a sample of a functional fluid, (b) placing the sample of the functional fluid upon the test medium impregnated with a stable reduced redox indicator, (c) waiting for an effective period of time to allow for the reaction between the components of the functional fluid and the redox indicator, d) making a visual determination of the test medium using the printed instructions and/or comparative visual indicia depicting the functional fluid (in various) conditions containing oxidizing species and/or oxidization byproducts; e.g., in various colors from green to blue as a guide for qualitative determination of an automatic transmission fluid.

It is not necessary that the sample be taken during actual operation of the engine or other equipment or machinery in order to obtain a representative sample of the functional fluid. The sample of functional fluid may be taken at any time before, during or after operation of the engine or equipment. The functional fluid sample can be new, used or combinations thereof.

The apparatus is comprised of a package that can be sealed containing the test medium treated with the redox indicator (in either a wet or dry state) and includes written instructions and a set of visual indicia depicting samples of the functional fluid disposed upon a test medium printed in color on the package with descriptive text. In one embodiment, the visual indicia shows a depiction of the functional fluid which is in an acceptable condition (i.e. light color) and also in an unacceptable condition (i.e. dark color).

The analysis of the condition of a functional fluid, for instance an automotive transmission fluid, is essentially dependent upon the reaction of components; i.e., oxidation byproducts in the functional fluid, with a redox indicator. For instance, automotive transmission fluid, as it is used, becomes oxidized forming oxidation byproducts and its inhibitor package becomes depleted, and there may be wear debris from the depletion of the anti-wear additives. During the service life of the automatic transmission fluid a point is reached where these components fall below a minimum acceptable level rendering the automatic transmission fluid unacceptable for further use. Continued use of an unacceptable automatic transmission fluid may cause damage to the transmission. When a sample of used automatic transmission fluid is obtained and the sample is placed upon a suitably treated test medium, the oxidative inhibitor additives in the automatic transmission fluid, if they have been consumed or depleted allow for oxidative species in the fluid such as perioxide which will react with the redox indicator changing its color from (colorless) to various shades of blue or green depending on the concentration of the oxidizing species and presence of metal contaminants. The greater the concentration of oxidizing species, the more color change occurs. The presence or absence of a color change and the relative intensity of the color provides a means for qualitative analysis of the test sample; therefore, the method results in the operator determining whether or not the functional fluid needs to be modified, additized and/or changed.

### Specific Embodiment

A sample of the functional fluid to be tested is applied to a test medium prepared as described below. The results are analyzed visually after the functional fluid has reaction with the redox indicator in the test medium.

### EXAMPLE 1

The test strips are prepared at room temperature as follows:
(1) About a 0.05% wt. solution of methylene blue is prepared in about isopropyl alcohol.
(2) To that solution is added excess di(2-ethylhexyl)dithiophosphoric acid (about 0.6% wt.).
(3) The methylene blue is reduced to its colorless form with corresponding formation of the disulfide of the dithiophosphoric acid.
(4) The excess dithiophosphoric acid forms a salt of (II) which stabilizes it.
(5) The alcohol solution of the redox indicator is then applied to blotter paper and the alcohol evaporated producing a dry white test strip.
(6) On exposure to hydroperoxides in organic media, the test strip turns various shades of blue or green depending on the concentration of oxidizing species and the presence of metal contaminants (e.g., iron and copper ions).

### EXAMPLE 2

Drain samples were taken from an automatic transmissions (“AT”) of 29 vehicles and evaluated using test strips prepared as in Example 1. A good correlation was observed between mileage on the AT fluids, wear metals (Fe, Pb, Cu) as determined by ICP emission spectroscopy analysis, and the observed colors produced on the test strips prepared as in Example 1 as seen in Table 1.

TABLE 1

| | Mileage on | Total % | Wipe | ASTM |
|---|---|---|---|---|
| | At Fluid | Wear Metals | Color | D664-04 |
| 2001 Ford Ranger | 2,000 | 0.0124 | Red | 2.03 |
| 2005 Honda Accord | 10,741 | 0.0069 | Red | 1.03 |
| 2001 Dodge Intrepid | 26,610 | 0.0095 | Red | 1.96 |
| 2003 Toyota Tacoma | 36,000 | 0.0187 | Red | 0.81 |
| 2003 Toyota Tacoma | 45,000 | 0.0150 | Red | 1.57 |
| 2001 Nissan Altima | 54,000 | 0.0183 | Red | 0.79 |
| 1996 Ford Winstar | 83,910 | 0.0350 | Blue | 1.01 |
| 2001 Ford winstar | 75,000 | 0.0398 | Green | 1.28 |
| 1996 Chrysler LHS | 74,131 | 0.0534 | Blue | 1.48 |
| 1997 Ford Taurus | 103,000 | 0.0757 | Green | 1.55 |
| 1999 Dodge Grand | 117,000 | 0.0510 | Green | 2.25 |
| Caravan | | | | |

The total wear metals are the combined percents of Cu, Fe, and Pb in the automatic transmission fluid. A green wipe indicates a fluid in bad condition, blue indicates a fluid that needs to be changed and red is a fluid in good condition.

While the invention has been illustrated and described, it will be appreciated that various changes can be made therein without departing from the spirit and scope of the invention, with the scope of the present invention being defined by the following claims.

We claim:

1. The present invention is a method to determine the condition of a functional fluid comprising
(1) obtaining a sample of a functional fluid,
(2) contacting the sample of the functional fluid on a test medium impregnated with a stable reduced indicator (dye) that produces a change in color in response to oxidizing species in the functional fluid,
(3) waiting for an effective period of time for the functional fluid sample to react with the indicator,
(4) analyzing the results of the reaction by determining or comparing the resultant color change resulting from the oxidized form of the indicator (dye) with the initial color of the indicator on the test medium; and
(5) determining the condition of the functional fluid

2. The method of claim 1 wherein the functional fluid is selected from the group consisting of automatic transmission fluids, traction drive transmission fluids, manual transmission fluids, power steering fluids, antifreeze fluids, lubricating oils, greases, crankcase lubricants, mineral oils, oils with Group 1 base oils, differential lubricants, turbine lubricants, gear lubricants, gear box lubricants, axle lubricants, farm tractor fluids, transformer fluids, compressor fluids, cooling system fluids, metal working fluids, hydraulic fluids, industrial fluids, and mixtures thereof.

3. The method of claim 1 wherein the functional fluid is selected from the group consisting of automatic transmission fluids, air compressors lubricants and turbine lubricants.

4. The method of claim 1 wherein the concentration of oxidizing species in the functional fluid is at least a concentration greater than about 0.1 ppm calculated as hydrogen peroxide.

5. The method of claim 1 wherein the redox indicator is used in the range of about 0.01 wt. % to about 1 wt % of the solution applied to the test medium.

6. The method of claim 1 wherein the redox indicator is selected from the group consisting of neutral red, safranine T or O, indigo, indigo carmine, methylene blue, thionine, thymolindophenol, 2,6-dichlorophenolindophenol, gallocyanine, nile blue, variamine blue, diphenyl amine, diphenylamine-4-sulfonic acid, barium salt, tris(2,2-dipyridyl)iron(II)sulfate, N-phenylanthranilic acid, ferroin, nitroferroin, 5,6-dimethylferroin, 4-amino-4′-methyldiphenylamine, diphenylbenzindine-disulfonic acid, o-dianisidine, 3,3′-dimethylnaphthidine, 3,3′-dimethylnaphthidine disulfonic acid, bis(5-bromo-1,10-phenanthroline)ruthenium(II)dinitrate, tris(5-nitro-1,10-phenanthroline)iron(II)sulfate, Iron(II)-2,2′,2″-tripyridine sulfate, tris(4,7-biphenyl-1,10-phenanthroline) iron(II)disulfate, o,m′-diphenylaminedicarboxylic acid setopaline, p-nitrodiphenylamine, tris(1,10-phenanthroline)-iron(II)sulfate, setoglaucine O, xylene cyanole FF, erioglaucine A, eriogreen, tris(2,2′-bipyridine)-iron(II) hydrochloride, 2-carboxydiphenylamine [N-phenyl-anthranillic acid], benzidine dihydrochloride, o-toluidine, bis(1,10-phenanthroline)-osmium(II) perchlorate, diphenylamine-4-sulfonate Na salt), 3,3′-dimethoxybenzidine dihydrochloride [o-dianisidine], ferrocyphen, 4′-ethoxy-2,4-diaminoazobenzene, N,N-diphenylbenzidine, diphenylamine, N,N-dimethyl-p-phenylenediamine, variamine blue B hydrochloride, N-phenyl-1,2,4-benzenetriamine, bindschedler's green, 2,6-dichloroindophenol (Na salt), 2,6-dibromophenolindophenol, brilliant cresyl blue [3-amino-9-dimethyl-amino-10-methylphenoxyazine chloride], Iron(II)-tetrapyridine chloride, starch (soluble potato, I₃ present), gallocyanine (25° C.), nile blue A [aminonaphthodiethylamino-phenoxazine sulfate], indigo-5,5′,7,7′-tetrasulfonic acid (Na salt), indigo-5,5′,7-trisulfonic acid (Na salt), indigo-5,5′-disulfonic acid (Na salt), phenosatranine, indigo-5-monosulfonic acid (Na salt), bis(dimethylglyoximato)-iron(II)chloride, Induline scarlet, and mixtures thereof.

7. The method of claim 1 wherein the redox indicator is selected from the group consisting of methylene blue, p-Nitrodiphenyl-amine, N,N-diphenylbenzidine, diphenylamine, and neutral red.

8. The method of claim 1 wherein the test medium is compatible with the redox indicator and the test medium comprises paper, cellulosic material, chromatography paper, filter paper, polymeric fibers, natural fibers, fabrics, polypropylene woven fabric, nonwoven fabric, metal, glass, plastic, composite materials, and combinations thereof.

9. The method of claim 1 wherein the analysis occurs after an effective period to allow for the reaction between functional fluid and the redox indicator.

10. The method of claim 9 wherein the reaction is in the range of about 1 second to about 1 hour.

11. The method of claim 1 comprising the steps wherein determining the condition of the fluid is selected from the group consisting of visually comparing the test medium against a set of comparative visual indicia depicting the functional fluid and at least one different condition as a guide, using printed instructions as a guide, comparing photographs depicting at least one different condition, and combinations thereof.

12. A test kit for the analysis of functional fluids comprising a test medium impregnated with a stable reduced indicator dye and a method to determine the quality of the condition of the fluid selected from the group consisting of instruction, pictures, drawings, photographs, and combinations thereof.

13. The test kit of claim 12 wherein the stable redox indicator produces a color change in response to oxidizing species in the functional fluid.

14. The test kit of claim 12 wherein the stable redox indicator is selected from the Group consisting of neutral red, safranine T or O, indigo, indigo carmine, methylene blue, thionine, thymolindophenol, 2,6-dichlorophenolindophenol, gallocyanine, nile blue, variamine blue, diphenyl amine, diphenylamine-4-sulfonic acid, barium salt, tris(2,2dipyridyl)iron(II)sulfate, N-phenylanthranilic acid, ferroin, nitroferroin, 5,6-dimethylferroin, 4-amino-4′-methyldiphenylamine, diphenylbenzindine-disulfonic acid, o-dianisidine, 3,3′-dimethylnaphthidine, 3,3′-dimethylnaphthidine disulfonic acid, bis(5-bromo-1,1 0-phenanthroline)ruthenium(II)dinitrate, tris(5-nitro-1,10-phenanthroline)iron(II)sulfate, Iron(II)-2,2′,2″-tripyridine sulfate, tris(4,7-biphenyl-1,10-phenanthroline)iron(II)disulfate, o,m′-diphenylaminedicarboxylic acid setopaline, p-nitrodiphenylamine, tris(1,10-phenanthroline)-iron(II) sulfate, setoglaucine O, xylene cyanole FF, erioglaucine A, eriogreen, tris(2,2′-bipyridine)-iron(II)hydrochloride, 2-carboxydiphenylamine[N-phenyl-anthranillic acid], benzidine dihydrochloride, o-toluidine, bis(1,10-phenanthroline)-osmium(II)perchlorate, diphenylamine-4-sulfonate Na salt), 3,3′-dimethoxybenzidine dihydrochloride[o-dianisidine], ferrocyphen, 4′-ethoxy-2,4-diaminoazobenzene, N,N-diphenylbenzidine, diphenylamine, N,N-dimethyl-p-phenylenediamine, variamine blue B hydrochloride, N-phenyl-1,2,4-benzenetriamine, bindschedler's green, 2,6-dichloroindophenol (Na salt), 2,6-dibromophenolindophenol, brilliant cresyl blue [3-amino-9-dimethyl-amino-10-methylphenoxyazine chloride], Iron(II)-tetrapyridine chloride, starch (soluble potato, I₃ present), gallocyanine (25° C.), nile blue A [aminonaphthodiethylamino-phenoxazine sulfate], indigo-5,5′,7,7′-tetrasulfonic acid (Na salt), indigo-5,5′,7-trisulfonic acid (Na salt), indigo-5,5′-disulfonic acid (Na salt), phenosatranine, indigo-5-monosulfonic acid (Na salt), bis(dimethylglyoximato)-iron(II)chloride, Induline scarlet, and mixtures thereof.

15. The test kit of claim 12 further comprising a set of comparative visual indicia comprising two representations of a functional fluid disposed upon a same, similar or different test media and wherein one is in acceptable condition and wherein the other is in unacceptable condition.

16. The test kit of claim 12 wherein the functional fluid is selected from the group consisting of automatic transmission fluids, traction drive transmission fluids, manual transmission fluids, power steering fluids, antifreeze fluids, lubricating oils, greases, crankcase lubricants, mineral oils, oils with Group 1 base oils, differential lubricants, turbine lubricants, gear lubricants, gear box lubricants, axle lubricants, farm tractor fluids, transformer fluids, compressor fluids, cooling system fluids, metal working fluids, hydraulic fluids, industrial fluids, and mixtures thereof.

17. The test kit of claim 12 wherein the functional fluid is selected from the group consisting of automatic transmission fluids, traction drive transmission fluids and mixtures thereof.
